(19) United States
(12) Patent Application Publication
(10) Pub. No.: US 2021/0326429 A1
(43) Pub. Date: Oct. 21, 2021

(54) ACCESS CONTROL METHOD AND DEVICE, ELECTRONIC DEVICE AND STORAGE MEDIUM

(71) Applicant: SHENZHEN SENSETIME TECHNOLOGY CO., LTD., Shenzhen (CN)

(72) Inventors: Wenzhong JIANG, Shenzhen (CN); Yi LIU, Shenzhen (CN); Siting HU, Shenzhen (CN); Hongbin ZHAO, Shenzhen (CN); Chen CHEN, Shenzhen (CN)

(21) Appl. No.: 17/361,642

(22) Filed: Jun. 29, 2021

Related U.S. Application Data
(63) Continuation of application No. PCT/CN2020/085380, filed on Apr. 17, 2020.

(30) Foreign Application Priority Data
Jun. 26, 2019 (CN) 201910561375.8

(51) Int. Cl. G06F 21/36; G06F 21/60

(52) U.S. Cl. CPC G06F 21/36; G06F 21/604; G06F 21/602

(57) ABSTRACT

Provided are an access control method and device, and a storage medium. The method includes that: a collected image to be recognized is recognized to obtain a recognition result, where the image to be recognized includes a present graphic code; in condition that the recognition result indicates that the present graphic code is a target graphic code, the present graphic code is parsed to obtain user information and generation time contained in the present graphic code; and an access control device is controlled to be opened according to the user information and generation time in the present graphic code.

### CROSS-REFERENCE TO RELATED APPLICATIONS

This application is a continuation of International Patent Application No. PCT/CN2020/085380, filed on Apr. 17, 2020, which claims priority to Chinese Patent Application No. 201910561375.8, filed on Jun. 26, 2019. The disclosures of International Patent Application No. PCT/CN2020/085380 and Chinese Patent Application No. 201910561375.8 are hereby incorporated by reference in their entireties.

### BACKGROUND

At present, a graphic code may be used for access control in an access control scenario. However, when a graphic code is used for an access control, a graphic code recognizer is required to be online in real time, which cannot meet an identity recognition requirement in an offline scenario. Moreover, there may also be a certain security risk in the access control process by using the graphic code.

### SUMMARY

The disclosure relates to the technical field of security protection, and particularly to an access control method and device, an electronic device and a storage medium.

According to a first aspect of the embodiments of the disclosure, an access control method is provided, which may include that: a collected image to be recognized is recognized to obtain a recognition result, where the image to be recognized includes a present graphic code; in condition that the recognition result indicates that the present graphic code is a target graphic code, the present graphic code is parsed to obtain user information and generation time contained in the present graphic code; and an access control device is controlled to be opened according to the user information and generation time in the present graphic code.

According to a second aspect of the embodiments of the disclosure, an access control device is provided, which includes a recognition module, an acquisition module and an access control module. The recognition module is configured to recognize a collected image to be recognized to obtain a recognition result, where the image to be recognized includes a present graphic code. The acquisition module is configured to: in condition that the recognition result indicates that the present graphic code is a target graphic code, obtain user information and generation time contained in the present graphic code by parsing the present graphic code. The access control module is configured to control an access control device to be opened according to the user information and generation time in the present graphic code.

According to a third aspect of the embodiments of the disclosure, an electronic device is provided, which includes a processor and a memory configured to store instructions executable by the processor, where the processor is configured to implement the access control method according to the first aspect of the embodiments of the disclosure as described above.

According to a fourth aspect of the embodiments of the disclosure, a computer-readable storage medium is provided, in which computer program instructions are stored, where the computer program instruction, when being executed by a processor, cause the processor to implement the access control method according to the first aspect of the embodiments of the disclosure as described above.

According to a fourth aspect of the embodiments of the disclosure, an access control device is provided, including a processor and a memory configured to store instructions executable by the processor, where the processor is configured to implement the access control method according to the first aspect of the embodiments of the disclosure.

It is to be understood that the above general description and the following detailed description are only exemplary and explanatory and are not intended to limit the disclosure.

Further features and aspects of the disclosure will become apparent from the following detailed descriptions made to exemplary embodiments with reference to the drawings.

### BRIEF DESCRIPTION OF THE DRAWINGS

The accompanying drawings, which are incorporated in and constitute a part of this specification, illustrate embodiments consistent with the disclosure and, together with the specification, serve to describe the technical solutions of the embodiments of the disclosure.

FIG. 1 is a flowchart of an access control method according to an embodiment of the disclosure.

FIG. 2 is a flowchart of an example of an access control method according to an embodiment of the disclosure.

FIG. 3 is a flowchart of an example of an access control method according to an embodiment of the disclosure.

FIG. 4 is a flowchart of an example of an access control method according to an embodiment of the disclosure.

FIG. 5 is a flowchart of an example of an access control method according to an embodiment of the disclosure.

FIG. 6 is a block diagram of an access control device according to an embodiment of the disclosure.

FIG. 7 is a block diagram of an example of an electronic device according to an embodiment of the disclosure.

### DETAILED DESCRIPTION

Various exemplary embodiments, features and aspects of the disclosure will be described below in detail with reference to the drawings, in which the same reference numbers in different drawings denote functionally identical or similar components. Although various aspects of the embodiments are illustrated in the drawings, the drawings, unless otherwise specified, are not necessarily drawn to scale.

The special term “exemplary” used herein refers to “as an example, embodiment or illustration”. Any “exemplarily” embodiment described herein may not be explained to be superior to or better than other embodiments.

The term “and/or” used throughout the description is only an association relationship describing associated objects and represents that three relationships may exist. For example, A and/or B may represent three conditions: i.e., independent existence of A, existence of both A and B and independent existence of B. In addition, term “at least one” in the disclosure represents any one of multiple or any combination of at least two of multiple. For example, including at least one of A, B and C may represent including any one or more elements selected from a set formed by A, B and C.

In addition, more details are given below in the examples to better illustrate the embodiments of the disclosure. It is understood by those skilled in the art that the embodiments of the disclosure may still be implemented even without some specific details. In some examples, methods, means, components and circuits familiar to those skilled in the art are not described in detail, so as to highlight the subject matter of the embodiments of the disclosure.

According to an access control solution provided in the embodiments of the disclosure, a collected image to be recognized may be acquired; in condition that the image to be recognized includes a graphic code, the present graphic code may be recognized to obtain a recognition result; in condition that the recognition result indicates that the present graphic code is a target graphic code, user information and generation time contained in the present graphic code may be obtained by parsing the present graphic code; and then an access control device is controlled to be opened based on the user information and generation time in the present graphic code. Since the present graphic code contains the generation time, the condition that the access control device is opened for many times by use of the same graphic code may be prevented by use of generation time of a previous graphic code, and thus the security and reliability of access control based on the image to be recognized may be improved. In addition, the access control solution provided in the embodiments of the disclosure can be applied to an offline scenario and meets the requirements of a user on access control in the offline scenario.

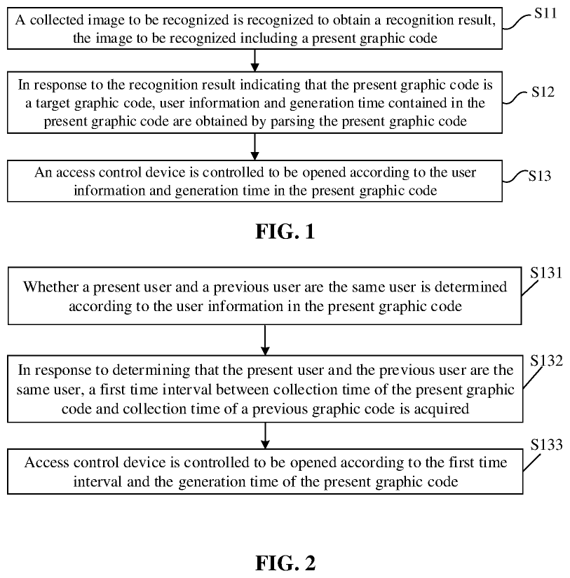

FIG. 1 is a flowchart of an access control method according to an embodiment of the disclosure. The access control method may be executed by an access control device, a terminal device or an electronic device of another type. The access control device may be an access control terminal, a remote access control device, an access control machine and the like. The terminal device may be User Equipment (UE), a mobile device, a user terminal, a terminal, a cell phone, a cordless phone, a Personal Digital Assistant (PDA), a handheld device, a computing device, a vehicle device, a wearable device and the like. The terminal device may control whether an access control device is opened or not. In some possible implementation modes, the access control method may be implemented in a manner that a processor calls a computer-readable instruction stored in a memory. The access control method of the embodiment of the disclosure will be described below with the condition that an execution body is an access control terminal as an example.

As shown in FIG. 1, the access control method may include the following operations S11 to S13.

In S11, a collected image to be recognized is recognized to obtain a recognition result, where the image to be recognized includes a present graphic code.

In the embodiment of the disclosure, for example, the access control method is executed by an access control terminal. The access control terminal may collect the image to be recognized, or, the access control terminal may receive the image to be recognized that is collected by another device. The image to be recognized may include the present graphic code, or may also include a face image of a target object. In the embodiment of the disclosure, the target object refers to a person to be recognized to pass through an access control. Under the condition that the image to be recognized includes the present graphic code, the access control terminal may acquire the present graphic code from the image to be recognized, and recognize the present graphic code in a preset recognition manner to obtain a recognition result. Exemplarily, a recognition solution may be called from a software development kit stored to recognize the present graphic code in the image to be recognized. For example, a ZBar algorithm is called to rapidly acquire the present graphic code in the image to be recognized, so as to pass the access control in a relatively short time (for example, in one second) or output an error prompt (for example, three seconds), thereby implementing high access control efficiency while ensuring the access control security.

In some optional examples, the present graphic code may be generated by another device. For example, a user terminal may generate the present graphic code according to an operation of a present user. The present graphic code may contain verification information for access control, and the verification information may include generation time and user information. The generation time may identify a generation moment when the present graphic code is generated, and the user information may be identification information of the present user, for example, identification information such as a user name and a user number. The present graphic code may include any one of a barcode, a two-dimensional code, a digital code, a text code and the like. For example, under the condition that the present user opens an access control device by use of a two-dimensional code, the present graphic code is the two-dimensional code, and a generation device for generating the present graphic code may be UE. The user terminal may generate the two-dimensional code according to the operation of the present user and contain a generation moment of the two-dimensional code and the user name of the present user in the two-dimensional code. The present user may present the two-dimensional code generated by the user terminal to the access control terminal. The access control terminal may collect the image to be recognized including the two-dimensional code and recognize the two-dimensional code to obtain the recognition result.

In a possible implementation mode, in the process of recognizing the collected present graphic code to obtain the recognition result, a present graphic code may be acquired, the present graphic code is parsed to obtain character information, and the character information is decrypted in a preset decryption manner to obtain the recognition result of the present graphic code. Herein, the preset decryption manner may be obtained in advance by negotiation between the access control terminal and the generation device for generating the graphic code. The access control terminal, after acquiring the present graphic code of the image to be recognized, may preliminarily recognize the present graphic code to determine a type of the present graphic code and then parse the present graphic code to obtain the character information in a decoding manner matched with the type of the present graphic code. The character information may be obtained by encrypting the user information and the generation time, so that the access control terminal cannot directly obtain the user information and the generation time through the character information parsed. The access control terminal may decrypt the character information obtained by parsing the graphic code in the preset decryption manner, for example, a Data Encryption Standard (DES)-based decryption manner, predetermined by negotiation with the device generating the graphic device. In case of successful decryption, it may be considered that the recognition result of the present graphic code is a target graphic code, or otherwise it may be considered that the recognition result of the present graphic code is a non-target graphic code.

In the embodiment, in the process of recognizing the collected image to be recognized, whether decrypted information obtained by decryption is in a preset format may further be determined after the character information obtained by parsing the graphic code is successfully decrypted. If the obtained decrypted information is in the preset format, it may be considered that the recognition result of the present graphic code is the target graphic code, or otherwise it may be considered that the recognition result of the present graphic code is the non-target graphic code.

In S12, in condition that the recognition result indicates that the present graphic code is a target graphic code, user information and generation time contained in the present graphic code are obtained by parsing the present graphic code.

In the embodiment of the disclosure, the access control terminal may determine whether the present graphic code in the image to be recognized is the target graphic code according to the recognition result of the image to be recognized. If the recognition result indicates that the present graphic code is the target graphic code, the user information and generation time obtained by parsing the present graphic code are acquired. Since the access control terminal may predetermine the decryption manner for the graphic code with the device generating the graphic code, the access control terminal may obtain the user information and generation time in the present graphic code under an offline condition to implement recognition of the present graphic code and information acquisition in an offline manner, so that the requirements of the user to use the graphic code for access control in the offline condition.

In S13, an access control device is controlled to be opened according to the user information and generation time in the present graphic code.

In the embodiment of the disclosure, a user identity of the present user may be verified by use of the user information in the present graphic code, so as to avoid opening an access control device to a user without any access permission. Whether the present graphic code is a previous graphic code may be determined by use of the generation time contained in the present graphic code to avoid the condition that the access control device is opened for many times by use of the same graphic code, thereby avoiding security problems caused by stolen of graphic codes. The present graphic code is verified through the user information and generation time contained in the present graphic code, the access control device may be controlled to be opened when a verification result indicates that verification succeeds, and prompt information may be output when the verification result indicates that the verification fails. The output prompt information is to prompt the present user to input another image to be recognized or prompt the present user that the verification fails.

In some optional examples of the disclosure, after the access control device is controlled to be opened, the method may further include that: collection time of a previous graphic code is updated by using collection time of the present graphic code. In such a manner, the access control terminal, after controlling the access control device to be opened, may reset the stored collection time of the previous graphic code by use of the collection time of the present graphic code, and determine the collection time of the present graphic code as a reference condition for next access control for use in the next access control.

In some implementation modes, the method may further include that: when the recognition result indicates that the present graphic code is a non-target graphic code, the present graphic code is uploaded to a server; a verification result returned by the server is received; when the verification result indicates that verification succeeds, the access control device is controlled to be opened; and when the verification result indicates that the verification fails, prompt information indicating that verification fails is output. The server is configured to perform access permission verification on the present graphic code.

In the implementation modes, under the condition that the access control terminal cannot decrypt the present graphic code in the preset decryption manner, access authority verification of the access control device may be performed on the present graphic code through the server, and the server may return the verification result to the access control terminal. Under the condition that the verification result is that verification succeeds, the access control terminal may open the access control device, or otherwise may output the prompt information indicating that verification fails. In an implementation mode, the access control terminal may output the prompt information through its own multimedia component (for example, an audio and/or video output component) to prompt the present user that verification fails. In another implementation mode, the access control terminal may also send the prompt information to a user terminal to prompt the present user that verification fails, where the user terminal is a terminal that establishes a connection with the access control terminal in advance. A user corresponding to the user terminal may be an owner of a house corresponding to the access control terminal, or may also be a maintenance operator of the access control terminal, which will not be limited in the embodiment of the disclosure.

In the embodiment, under the condition that the recognition result indicates that the present graphic code is the non-target graphic code, it may be considered that the access control terminal does not negotiate in advance with the device generating the present graphic code. Since the device generating the present graphic code is provided by a third-party platform, the access control terminal cannot decrypt the graphic code in the preset decryption manner. The access control terminal may upload the present graphic code to the server when failing to decrypt the present graphic code, and the server performs access authority verification on the present graphic code. Herein, the server may be a server of the third-party platform, and the third-party platform may be a controller having access control authority, for example, a generation party of the access control terminal and a secure third party pre-stored by the access control terminal. The access control terminal may pre-store a link address of the third-party platform having the access control authority or add the link address of the third-party platform having the access control authority according to an application requirement. Therefore, the access control terminal may upload the present graphic code to the server of the third-party platform when the present graphic code is the non-target graphic code to verify the present graphic code through the server.

The access control solution provided in the embodiment of the disclosure can not only support access control based on a graphic code in a specific format in an offline scenario, but also support access control based on any graphic code in an online scenario, which satisfies the access control requirements in offline and online scenarios better, and has a higher applicability.

In a possible implementation mode of the disclosure, the image to be recognized includes a face image. The method further includes that: the face image is compared with a pre-stored face image, and the access control device is controlled to be opened according to a comparison result.

In the embodiment, the access control terminal may collect the face image of the present user to control the access control device to be opened through the collected face image of the present user. The access control terminal may compare the face image of the present user and the pre-stored face image to obtain the comparison result. If the comparison result indicates that the face image of the present user is matched with the pre-stored face image, the access control device may be controlled to be opened, or otherwise the prompt information indicating that verification fails may be output to prompt the present user that access authority verification fails. When access control verification is performed on the present user, access control verification may be selected to be performed by use of the graphic code, or, access control verification may be selected to be performed by use of the face image.

In some optional embodiments of the disclosure, the method further includes that: under the condition that the face image is mismatched with the pre-stored face image, the access control terminal may output the prompt information for prompting the present user to provide a graphic code for access authority verification. In such a manner, under the condition that verification based on the face image fails, the present user may be verified again by use of the graphic code. Therefore, a diversity of access control manners are provided for the user, and convenience is brought to the user.

In the embodiments of the disclosure, the collected image to be recognized may be recognized to obtain the recognition result, where the image to be recognized including the present graphic code; in condition that the recognition result indicates that the present graphic code is the target graphic code, the user information and generation time contained in the present graphic code are obtained by parsing the present graphic code; and an access control device is controlled to be opened according to the user information and generation time in the present graphic code. In such a manner, the present graphic code may be verified through the user information and generation time contained in the present graphic code, which improves the security of access control based on the graphic code. In addition, the access control solutions provided in the embodiments of the disclosure may support an offline scenario and meet a requirement of a user on access control in the offline scenario.

FIG. 2 is a flowchart of an example of an access control method according to an embodiment of the disclosure.

In a possible implementation mode, the operation S13 may include the following operations S131 to S133.

In S131, whether a present user and a previous user are the same user or not is judged according to the user information contained in the present graphic code.

In the embodiment, the access control terminal may save user information and generation time extracted from a graphic code in each access control process and thus may record related information of each access control process, for example, recording related information such as the user information and generation time extracted from the graphic code, collection time of each graphic code and whether each graphic code is successfully verified, to enable the user to invoke a corresponding graphic-code-based access control record. On this basis, in a process of controlling the access control device to be opened according to the user information and generation time contained in the present graphic code, the stored user information and generation time contained in the previous graphic code are acquired, and a user identity of the previous user may be determined through the user information in the previous graphic code. It can be understood that the previous graphic code is a last graphic code prior to the present graphic code. That is, in a process of collecting graphic codes according to a time sequence, if the present graphic code is the N-th collected graphic code, the previous graphic code is the (N−1)-th collected graphic code. The previous user is a user corresponding to the user information contained in the previous graphic code.

In an example, in a process of determining whether the present user and the previous user are the same user according to the user information in the present graphic code, it may be determined whether the user information contained in the present graphic code is the same as user information contained in the previous graphic code; when the user information contained in the present graphic code is the same as the user information contained in the previous graphic code, it is determined that the present user and the previous user are the same user; and when the user information contained in the present graphic code is different from the user information contained in the previous graphic code, it is determined that the present user and the previous user are different users. For example, the access control terminal may compare a user name contained in the present graphic code and a user name corresponding to the stored previous graphic code; if a comparison result indicates that they are the same, it may be considered that the present user and the previous user are the same user; and if the comparison result indicates that they are different, it may be considered that the present user and the previous user are different users.

In S132, when the present user and the previous user are the same user, a first time interval between collection time of the present graphic code and collection time of a previous graphic code is acquired.

In the embodiment, if it is determined that the present user and the previous user are different users, the access control terminal may acquire the collection time of the present graphic code and acquire the collection time of the previous graphic code, calculate a time difference value between the collection time of the present graphic code and the collection time of the previous graphic code, and determine the time difference value as the first time interval.

In S133, the access control device is controlled to be opened according to the first time interval and the generation time of the present graphic code.

In the embodiment, the first verification may be performed on an access authority of the first-time present graphic code by use of the first time interval, and then the second verification is performed on the access authority of the present graphic code by use of the generation time of the present graphic code, so that access authority verification may be performed for many times on the present graphic code to improve the security of the access control.

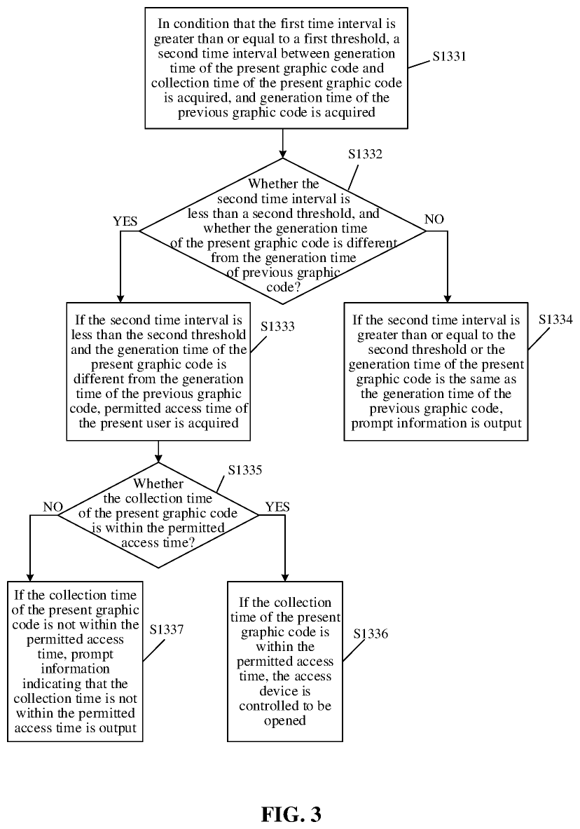

FIG. 3 is a flowchart of an example of an access control method according to an embodiment of the disclosure.

In an example, S133 may include the following operations S1331 to S1337.

In S1331, under the condition that the first time interval is greater than or equal to a first threshold, a second time interval between the generation time of the present graphic code and the collection time of the present graphic code is acquired, and generation time of the previous graphic code is acquired.

In S1332, it is determined whether the second time interval is less than a second threshold and whether the generation time of the present graphic code is different from the generation time of the previous graphic code; in response to that a determination result is YES, S1333 is executed; and in response to that a determination result is NO, S1334 is executed.

In S1333, under the condition that the second time interval is less than the second threshold and the generation time of the present graphic code is different from the generation time of the previous graphic code, permitted access time of the present user is acquired, and S1335 is further executed.

In S1334, under the condition that the second time interval is greater than or equal to the second threshold and/or the generation time of the present graphic code is the same as the generation time of the previous graphic code, prompt information is output.

In the embodiment, if the second time interval is greater than or equal to the second threshold, it is indicated that the second time interval between the generation time of the present graphic code and the collection time of the present graphic code reaches an allowed maximum difference. If the generation time of the present graphic code is the same as the generation time of the previous graphic code, it is indicated that the present graphic code is not the latest graphic code. If these two conditions occur, it may be considered that use time of the present graphic code has expired or the present graphic code is a graphic code being stolen, and the prompt information may be output to prompt the present user to input another image to be recognized or prompt the present user that verification fails.

During verification of the access authority of the graphic code, the permitted access time corresponding to the user information may be determined according to the user information, and then whether the collection time corresponding to a present moment is within the determined permitted access time is determined. If the collection time is within the permitted access time, it may be determined that the verification result of the graphic code is that verification succeeds, and a target operation is executed, for example, the restriction of the access control device is removed. Otherwise, it may be determined that the verification result of the graphic code is that verification fails, and the present user may be prompted that the collection time is not within the permitted access time.

In S1335, whether the collection time of the present graphic code is within the permitted access time is determined; in response to that a determination result is YES, S1336 is executed; and in response to that the determination result is NO, S1337 is executed.

In S1336, under the condition that the collection time of the present graphic code is within the permitted access time, the access control device is controlled to be opened.

In the embodiment, under the condition that the user information of the present graphic code is the same as the user information of the previous graphic code, it is indicated that it is not the first time for access control over the present user, and thus the first time interval may be compared with the first threshold to obtain a comparison result, and whether to open the access control device is determined according to the comparison result. The first threshold may be preset, and for example, may be set to be 10 seconds. Under the condition that the first time interval is greater than or equal to the first threshold, it may be indicated that there is a certain time difference between two continuous access control verifications over the present user. The time difference is greater than or equal to each door access verification period of the access control terminal because the time interval between the two continuous access control verifications over the present user is too long probably due to a time error between the time of the device generating the present graphic code and the time of the access control terminal. Therefore, the access authority of the present graphic code may further be verified by use of the second time interval between the generation time in the present graphic code and the collection time of the present graphic code, the generation time of the present graphic code and the generation time of the previous graphic code.

In the embodiment, the second threshold may be an allowed maximum time interval of a difference between the generation time of the present graphic code and the collection time of the present graphic code under the condition that the time error between devices is considered. Therefore, when the second time interval is less than the second threshold, it may be considered that the second time interval is slightly long because of the time error between the device generating the present graphic code and the access control terminal, and it may be considered that the second time interval is reasonable. Moreover, under the condition that the generation time of the present graphic code is different from the generation time of the previous graphic code, it may be considered that the present graphic code is different from the previous graphic code, the permitted access time of the present user is acquired according to the user information contained in the present graphic code. Whether the collection time of the present graphic code is in the permitted access time is determined, and the access control device may be controlled to be opened if the collection time of the present graphic code is in the permitted access time.

In S1337, under the condition that the collection time of the present graphic code is not within the permitted access time, the prompt information indicating that the collection time is not within the permitted access time is output.

In the embodiment, if the collection time of the present graphic code is not in the permitted access time, it may be considered that the present user has no access authority, and the prompt information indicating that the collection time is not in the permitted access time may be sent to the user terminal of the present user to prompt the present user that the access control device may not be opened at present.

In the embodiment, the access control terminal may store user information of users permitted to access and permitted access time corresponding to each piece of user information, and the permitted access time corresponding to different user information may be the same or different. In some implementation modes, the access control terminal may record a correspondence between the user information of users permitted for access and the permitted access time, and thus whether the present user has an access authority of the access control device may be determined again by use of the stored permitted access time to implement security control over the access control device.

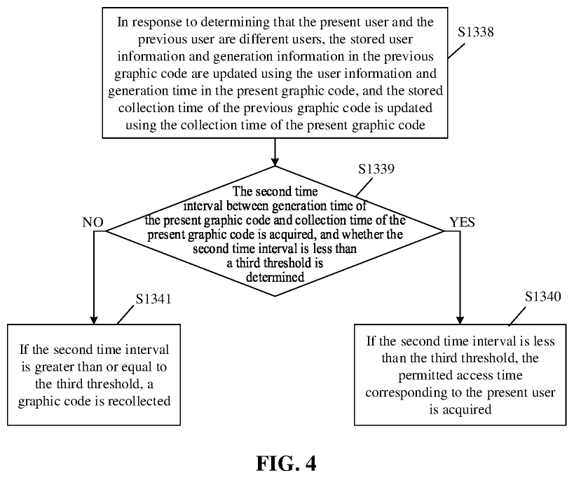

FIG. 4 is a flowchart of an example of an access control method according to an embodiment of the disclosure. In an example, as shown in FIG. 4, S133 may further include the following operations.

In S1338, under the condition that the present user and the previous user are different users, the stored user information and generation information contained in the previous graphic code are updated by using the user information and generation time in the present graphic code, and the stored collection time of the previous graphic code is updated by using the collection time of the present graphic code.

In the embodiment, under the condition that the user information contained in the present graphic code is different from the user information contained in the previous graphic code, it may be considered that the present user and the previous user are different users. Under the condition that the present user and the previous user are different users, the stored user information contained in the previous graphic code may be updated with the user information contained in the present graphic code, stored time information contained in the previous graphic code may be updated with time information contained in the present graphic code, and the stored collection time of the previous graphic code may be updated with the collection time of the present graphic code, for use in next access control authority verification.

In S1339, the second time interval between the generation time of the present graphic code and the collection time of the present graphic code is acquired, and whether the second time interval is less than a third threshold or not is determined. If the determination result is YES, S1340 is executed, otherwise S1341 is executed.

In the embodiment, the time difference between the generation time of the present graphic code and the collection time of the present graphic code may be calculated, and the time difference value is determined as the second time interval.

In S1340, under the condition that the second time interval is less than the third threshold, the permitted access time corresponding to the present user is acquired.

In the embodiment, after the second time interval is acquired, the second time interval may be compared with the set third threshold. If the second time interval is less than the set third threshold, it may be considered that the present graphic code is a valid graphic code. Then, the permitted access time corresponding to the present user may be acquired according to the user information contained in the present graphic code, and whether the collection time of the present graphic code is in the acquired permitted access time is determined. Under the condition that the collection time of the present graphic code is in the permitted access time, the access control device is controlled to be opened, referring to S1336. Under the condition that the collection time of the present graphic code is not in the permitted access time, the prompt information indicating that the collection time is not in the permitted access time is output, referring to S1337.

In an example, S133 may further include the following operation.

In S1341, under the condition that the second time interval is greater than or equal to the third threshold, a graphic code is recollected.

In the embodiment, the second time interval is greater than or equal to the third threshold probably because use time of the present graphic code has expired or there is time error between the device generating the present graphic code and the access control terminal. In this way, no operation is performed, and a next image to be recognized is continued to be read.

Through the access control solution provided in the embodiment of the disclosure, the access control terminal may support offline parsing of a graphic code in a specific format (a format predetermined by negotiation with a device generating the graphic code) and offline access control, and meanwhile, may also support offline and online access control based on the graphic code. In an access control process, authority of graphic code may be determined in multiple stages by use of time information, the condition that access is implemented for many times by use of the same graphic code or a graphic code stolen is used for access control may be prevented. Therefore, the security and reliability of access control based on the graphic code are improved.

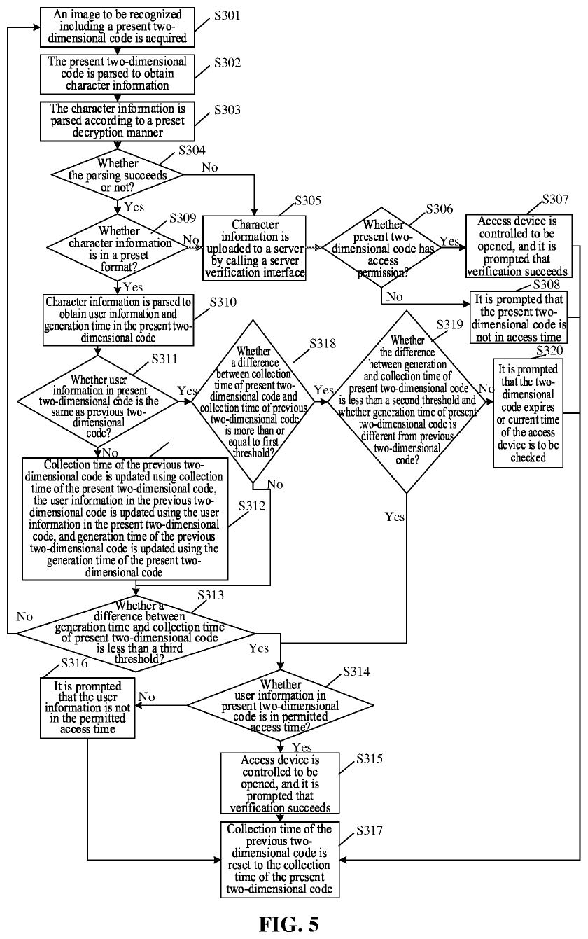

The access control solution provided in the embodiment of the disclosure will be described below through an example. In the example, a graphic code may be a two-dimensional code, an electronic device may be an access control terminal, and the access control solution may be applied to an application scenario that a present user opens an access control device by use of the two-dimensional code. As shown in FIG. 5, the following operations may be included.

In S301, the access control terminal acquires an image to be recognized including a present two-dimensional code.

In S302, the access control terminal parses the present two-dimensional code in the image to be recognized to obtain character information.

In S303, the access control terminal parses the character information according to a preset decryption manner (for example, a DES-based manner).

Herein, the access control terminal may negotiate in advance with a device for generating the present two-dimensional code to predetermine a preset encryption and decryption manner.

In S304, whether the parsing succeeds is determined; if parsing succeeds, S309 is executed; or if parsing fails, it may be considered that the present two-dimensional code is a two-dimensional code provided by a third-party platform, and S305 is executed.

In S305, the character information obtained by parsing the present two-dimensional code is uploaded to a server by calling a server verification interface.

In S306, the server determines whether the present two-dimensional code has an access authority; the server performs access authority verification on the character information of the present two-dimensional code and returns a verification result to the access control terminal. If a determination result is YES, S307 is executed; and if the determination result is NO, S308 is executed.

In S307, if the verification result indicates that verification succeeds, the access control terminal opens the access control device and prompts that verification succeeds.

In S308, if the verification result indicates that verification fails, it is prompted that the present two-dimensional code is not in permission access time.

In S309, it is determined whether the character information obtained by successful parsing is in a preset format (for example, whether it is character information in a JSON format). If the determination result is YES, it may be considered that the present two-dimensional code is a two-dimensional code for access control and may support offline access verification, and S310 is executed, otherwise S305 is executed.

In S310, the obtained character information is parsed to obtain a user Identifier (ID) (i.e., user information) contained in the present two-dimensional code: currentUserID, and obtain a timestamp (i.e., generation time) contained in the present two-dimensional code: currentTimestamp.

In S311, it is determined whether the user ID (currentUserID) contained in the present two-dimensional code is the same as a user ID (lastUserID) contained in a last two-dimensional code (or called a previous two-dimensional code). If the determination result is YES, S318 is executed, and if NO, S312 is executed.

In S312, recorded collection time (qrVerifyTime) of the last two-dimensional code is updated with collection time of the present two-dimensional code, a content of the recorded lastUserID is updated with currentUserID, and the recorded lastTimestamp of the last two-dimensional code is updated with the currentTimestamp of the present two-dimensional code.

In S313, it is determined whether a difference (second time interval) between the currentTimestamp contained in the present two-dimensional code and the collection time of the present two-dimensional code is less than a third threshold (for example, whether it is less than 10 seconds). If the difference is less than the third threshold, S314 is executed; or otherwise it may be indicated that the present two-dimensional code may be an expired two-dimensional code or it may be indicated that there is a time error between the time of the device generating the present two-dimensional code and the time of the access control terminal, no processing is performed, and S301 is executed to continue reading a next image to be recognized.

In S314, it is determined whether the user ID (currentUserID) in the present two-dimensional code is within permitted access time specified by a local access policy or not. If the user ID is in the permitted access time specified by the local access policy, S315 is executed; and if the user ID is not in the permitted access time specified by the local access policy, S316 is executed.

In the embodiment, the local access policy may record a correspondence between user IDs of users permitted for access and permitted access time, and the permitted access time corresponding to each user ID may be different. Therefore, the permitted access time corresponding to the user ID may be determined according to the user ID contained in the present two-dimensional code, and then whether the collection time of the present two-dimensional code is in the permitted access time may be determined.

In S315, the access control device is controlled to be opened, it is prompted that verification succeeds, and S317 is executed.

In S316, it is prompted that the user ID is not in the permitted access time, access is prohibited. Then, S317 is executed.

In S317, the recorded collection time (qrVerifyTime) of the last two-dimensional code is reset to the collection time of the present two-dimensional code, for use in a next verification process.

In S318, if the currentUserID in the present two-dimensional code is the same as the lastUserID in the last two-dimensional code, it is determined whether a difference (first time interval) between the collection time of the present two-dimensional code and the collection time of the last two-dimensional code is greater than or equal to a first threshold (for example, whether it is greater than 10 seconds or not). If the difference is greater than or equal to the first threshold, S319 is executed, or otherwise S313 is executed.

In S319, it is determined whether the difference (second time interval) between the currentTimestamp contained in the present two-dimensional code and the collection time of the present two-dimensional code is less than a second threshold (for example, whether it is less than 1 minute or not), and whether the currentTimestamp contained in the present two-dimensional code is the same as the lastTimestamp contained in the last two-dimensional code. If the difference (second time interval) between the currentTimestamp contained in the present two-dimensional code and the collection time of the present two-dimensional code is less than the second threshold (for example, less than 1 min), and the currentTimestamp contained in the present two-dimensional code is different from the lastTimestamp contained in the last two-dimensional code, it may be considered that there is a time error between the time of the device generating the present two-dimensional code and the time of the access control terminal, and the present two-dimensional code is valid, and then S314 is executed. If the difference (second time interval) between the currentTimestamp contained in the present two-dimensional code and the collection time of the present two-dimensional code is greater than or equal to the second threshold (for example, more than or equal to 1 minute) and/or the currentTimestamp contained in the present two-dimensional code is the same as the lastTimestamp contained in the last two-dimensional code, it may be considered that the present two-dimensional code is an expired two-dimensional code or may be a malicious attack two-dimensional code, and then S320 is executed.

In S320, it is prompted that the present two-dimensional code has expired, or, time of the device is prompted to be checked, and then S317 is executed.

In the example, in the process of implementing access control by use of the present graphic code, multiple stages of time-threshold-based determinations are set, which improves the security of access control based on the graphic code, and meanwhile considers the problem of access control failure caused by a time error between different devices (the device generating the graphic code and the access control terminal), and thus the reliability of access control based on the graphic code is improved.

It can be understood that each method embodiment mentioned in the disclosure may be combined to form combined embodiments without departing from principles and logics. For saving the space, elaborations are omitted in the disclosure.

In addition, the embodiments of the disclosure also provide an image processing device, an electronic device, a computer-readable storage medium and a program. All of them may be configured to implement any image processing method provided in the disclosure. Corresponding technical solutions and descriptions refer to the corresponding records in the method part and will not be elaborated.

It can be understood by those skilled in the art that, in the method of the specific implementation modes, the writing sequence of each step does not mean a strict execution sequence and is not intended to form any limit to the implementation process and a specific execution sequence of each step should be determined by functions and probable internal logic thereof.

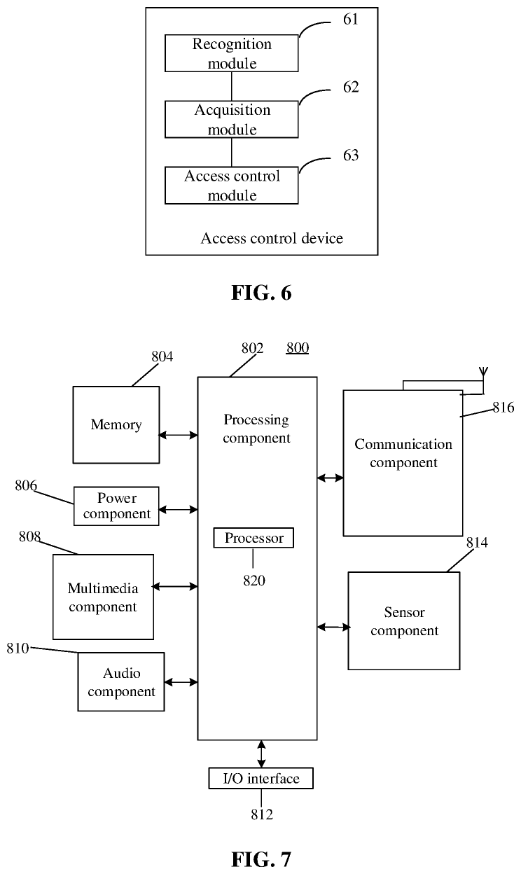

FIG. 6 is a block diagram of an access control device according to an embodiment of the disclosure. As shown in FIG. 6, the access control device includes a recognition module 61, an acquisition module 62 and an access control module 63.

The recognition module 61 is configured to recognize a collected image to be recognized to obtain a recognition result, the image to be recognized including a present graphic code.

The acquisition module 62 is configured to obtain user information and generation time contained in the present graphic code by parsing the present graphic code in condition that the recognition result indicates that the present graphic code is a target graphic code.

The access control module 63 is configured to control an access control device to be opened according to the user information and generation time contained in the present graphic code.

In a possible implementation mode, the recognition module 61 is configured to acquire the present graphic code, parse the present graphic code to obtain character information, and decrypt the character information in a preset decryption manner to obtain the recognition result of the present graphic code.

In a possible implementation mode, the device further includes a sending module and a receiving module. The sending module is configured to, under the condition that the recognition result indicates that the present graphic code is a non-target graphic code, upload the present graphic code to a server, the server being configured to perform access permission verification on the present graphic code.

The receiving module is configured to receive a verification result returned by the server.

The access control module is further configured to, control the access control device to be opened in condition that the verification result is that verification succeeds, and output prompt information indicating that verification fails in condition that the verification result indicates that verification fails.

In a possible implementation mode, the access control module 63 is configured to determine whether a present user and a previous user are the same user or not according to the user information contained in the present graphic code; under the condition that the present user and the previous user are the same user, acquire a first time interval between collection time of the present graphic code and collection time of a previous graphic code; and control the access control device to be opened according to the first time interval and the generation time of the present graphic code.

In a possible implementation mode, the access control module 63 is configured to determine whether the user information contained in the present graphic code is the same as user information contained in the previous graphic code; under the condition that the user information contained in the present graphic code is the same as the user information contained in the previous graphic code, determine that the present user and the last user are the same user, or otherwise determine that the present user and the previous user are different users.

In a possible implementation mode, the access control module 63 is configured to, under the condition that the first time interval is greater than or equal to a first threshold, acquire a second time interval between the generation time of the present graphic code and the collection time of the present graphic code and acquire generation time of the previous t graphic code; under the condition that the second time interval is less than a second threshold and the generation time of the present graphic code is different from the generation time of the previous graphic code, acquire permitted access time of the present user; and under the condition that the collection time of the present graphic code is within the permitted access time, control the access control device to be opened.

In a possible implementation mode, the access control module 63 is further configured to, under the condition that the collection time of the present graphic code is not within the permitted access time, output prompt information indicating that the collection time is not within the permitted access time.

In a possible implementation mode, the access control module 63 is further configured to, under the condition that the second time interval is greater than or equal to the second threshold or the generation time of the present graphic code is the same as the generation time of the previous graphic code, output the prompt information.

In a possible implementation mode, the access control module 63 is further configured to, under the condition that the present user and the previous user are different users, update the stored user information and generation information contained in the previous graphic code with the user information and generation time contained in the present graphic code and update the stored collection time of the previous graphic code with the collection time of the present graphic code; acquire the second time interval between the generation time of the present graphic code and the collection time of the present graphic code; under the condition that the second time interval is less than a third threshold, acquire the permitted access time corresponding to the present user; and under the condition that the collection time of the present graphic code is within the permitted access time, control the access control device to be opened.

In a possible implementation mode, the access control module 63 is further configured to, under the condition that the collection time of the present graphic code is not within the permitted access time, output the prompt information indicating that the collection time is not within the permitted access time.

In a possible implementation mode, the device further includes a collection module, configured to re-acquire a graphic code under the condition that the second time interval is greater than or equal to the third threshold.

In a possible implementation mode, the device further includes a storage module, configured to update the collection time of the previous graphic code with the collection time of the present graphic code after the access control device is controlled to be opened.

In a possible implementation mode, the image to be recognized includes a face image.

The access control module 63 is further configured to compare the face image of the present user and a pre-stored face image and control the access control device to be opened according to a comparison result.

In some embodiments, functions or modules of the device provided in the embodiment of the disclosure may be configured to execute the method described in the above method embodiment and specific implementation thereof may refer to the descriptions about the method embodiment and, for simplicity, will not be elaborated herein.

The embodiments of the disclosure also disclose a computer-readable storage medium, in which a computer program instruction is stored, the computer program instruction being executed by a processor to implement the method. The computer-readable storage medium may be a nonvolatile computer-readable storage medium.

The embodiments of the disclosure disclose an electronic device, which includes a processor and a memory configured to store instructions executable by the processor. The processor is configured to perform the method as described above. The electronic device may be provided as a terminal, a server or a device in another form.

FIG. 7 is a block diagram of an electronic device according to an exemplary embodiment. For example, the electronic device 800 may be any one of terminal devices such as a mobile phone, a computer, a digital broadcast terminal, a messaging device, a gaming console, a tablet, a medical device, exercise equipment and a PDA.

Referring to FIG. 7, the electronic device 800 may include one or more of the following components: a processing component 802, a memory 804, a power component 806, a multimedia component 808, an audio component 810, an Input/Output (I/O) interface 812, a sensor component 814, and a communication component 816.

The processing component 802 typically controls overall operations of the electronic device 800, such as the operations associated with display, telephone calls, data communications, camera operations, and recording operations. The processing component 802 may include one or more processors 820 to execute instructions to perform all or part of the steps in the abovementioned method. Moreover, the processing component 802 may include one or more modules which facilitate interaction between the processing component 802 and the other components. For instance, the processing component 802 may include a multimedia module to facilitate interaction between the multimedia component 808 and the processing component 802.

The memory 804 is configured to store various types of data to support the operation of the electronic device 800. Examples of such data include instructions for any application programs or methods operated on the electronic device 800, contact data, phonebook data, messages, pictures, video, etc. The memory 804 may be implemented by a volatile or nonvolatile storage device of any type or a combination thereof, for example, a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic disk or an optical disk.

The power component 806 provides power for various components of the electronic device 800. The power component 806 may include a power management system, one or more power supplies, and other components associated with generation, management and distribution of power for the electronic device 800.

The multimedia component 808 includes a screen providing an output interface between the electronic device 800 and a user. In some embodiments, the screen may include a Liquid Crystal Display (LCD) and a Touch Panel (TP). If the screen includes the TP, the screen may be implemented as a touch screen to receive an input signal from the user. The TP includes one or more touch sensors to sense touches, swipes and gestures on the TP. The touch sensors may not only sense a boundary of a touch or swipe action but also detect a duration and pressure associated with the touch or swipe action. The touch sensors may not only sense a boundary of a touch or swipe action but also detect a duration and pressure associated with the touch or swipe action. The front camera and/or the rear camera may receive external multimedia data when the electronic device 800 is in an operation mode, such as a photographing mode or a video mode. Each of the front camera and the rear camera may be a fixed optical lens system or have focusing and optical zooming capabilities.

The audio component 810 is configured to output and/or input an audio signal. For example, the audio component 810 includes a Microphone (MIC), and the MIC is configured to receive an external audio signal when the electronic device 800 is in the operation mode, such as a call mode, a recording mode and a voice recognition mode. The received audio signal may further be stored in the memory 804 or sent through the communication component 816. In some embodiments, the audio component 810 further includes a speaker configured to output the audio signal.

The I/O interface 812 provides an interface between the processing component 802 and a peripheral interface module, and the peripheral interface module may be a keyboard, a click wheel, a button and the like. The button may include, but not limited to: a home button, a volume button, a starting button and a locking button.

The sensor component 814 includes one or more sensors configured to provide status assessment in various aspects for the electronic device 800. For instance, the sensor component 814 may detect an on/off status of the electronic device 800 and relative positioning of components, etc., such as a display and small keyboard of the electronic device 800, and the sensor component 814 may further detect a change in a position of the electronic device 800 or a component of the electronic device 800, presence or absence of contact between the user and the electronic device 800, orientation or acceleration/deceleration of the electronic device 800 and a change in temperature of the electronic device 800. The sensor component 814 may include a proximity sensor configured to detect presence of an object nearby without any physical contact. The sensor component 814 may also include a light sensor, such as a Complementary Metal-Oxide Semiconductor (CMOS) or Charge Coupled Device (CCD) image sensor, configured for use in an imaging application. In some embodiments, the sensor component 814 may also include an acceleration sensor, a gyroscope sensor, a magnetic sensor, a pressure sensor or a temperature sensor.

The communication component 816 is configured to facilitate wired or wireless communication between the electronic device 800 and another device. The electronic device 800 may access a communication-standard-based wireless network, such as a Wireless Fidelity (WiFi) network, a 2nd-Generation (2G) or 3rd-Generation (3G) network or a combination thereof. In an exemplary embodiment, the communication component 816 receives a broadcast signal or broadcast associated information from an external broadcast management system through a broadcast channel In an exemplary embodiment, the communication component 816 further includes a Near Field Communication (NFC) module to facilitate short-range communication. For example, the NFC module may be implemented based on a Radio Frequency Identification (RFID) technology, an Infrared Data Association (IrDA) technology, an Ultra-WideBand (UWB) technology, a Bluetooth (BT) technology and another technology.

In the exemplary embodiment, the electronic device 800 may be implemented by one or more Application Specific Integrated Circuits (ASICs), Digital Signal Processors (DSPs), Digital Signal Processing Devices (DSPDs), Programmable Logic Devices (PLDs), Field-Programmable Gate Arrays (FPGAs), controllers, micro controller Units (MCUs), microprocessors or other electronic components, and is configured to execute the abovementioned method.

In the exemplary embodiment, the embodiments of the disclosure also provide a nonvolatile computer-readable storage medium, for example, a memory 804 including a computer program instruction. The computer program instruction may be executed by a processor 820 of an electronic device 800 to implement the abovementioned method.

The disclosure may be a system, a method and/or a computer program product. The computer program product may include a computer-readable storage medium, in which a computer-readable program instruction configured to enable a processor to implement each aspect of the disclosure is stored.

The computer-readable storage medium may be a physical device capable of retaining and storing an instruction used by an instruction execution device. For example, the computer-readable storage medium may be, but not limited to, an electric storage device, a magnetic storage device, an optical storage device, an electromagnetic storage device, a semiconductor storage device or any appropriate combination thereof. More specific examples (non-exhaustive list) of the computer-readable storage medium include a portable computer disk, a hard disk, a Random Access Memory (RAM), a ROM, an EPROM (or a flash memory), an SRAM, a Compact Disc Read-Only Memory (CD-ROM), a Digital Video Disk (DVD), a memory stick, a floppy disk, a mechanical encoding device, a punched card or in-slot raised structure with an instruction stored therein, and any appropriate combination thereof. Herein, the computer-readable storage medium is not explained as a transient signal, for example, a radio wave or another freely propagated electromagnetic wave, an electromagnetic wave propagated through a wave guide or another transmission medium (for example, a light pulse propagated through an optical fiber cable) or an electric signal transmitted through an electric wire.

The computer-readable program instruction described here may be downloaded from the computer-readable storage medium to each computing/processing device or downloaded to an external computer or an external storage device through a network such as the Internet, a Local Area Network (LAN), a Wide Area Network (WAN) and/or a wireless network. The network may include a copper transmission cable, optical fiber transmission, wireless transmission, a router, a firewall, a switch, a gateway computer and/or an edge server. A network adapter card or network interface in each computing/processing device receives the computer-readable program instruction from the network and forwards the computer-readable program instruction for storage in the computer-readable storage medium in each computing/processing device.

The computer program instruction configured to execute the operations of the disclosure may be an assembly instruction, an Instruction Set Architecture (ISA) instruction, a machine instruction, a machine related instruction, a microcode, a firmware instruction, state setting data or a source code or target code edited by one or any combination of more programming languages, the programming language including an object-oriented programming language such as Smalltalk and C++ and a conventional procedural programming language such as “C” language or a similar programming language. The computer-readable program instruction may be completely executed in a computer of a user or partially executed in the computer of the user, executed as an independent software package, executed partially in the computer of the user and partially in a remote computer, or executed completely in the remote server or a server. Under the condition that the remote computer is involved, the remote computer may be concatenated to the computer of the user through any type of network including an LAN or a WAN, or, may be concatenated to an external computer (for example, concatenated by an Internet service provider through the Internet). In some embodiments, an electronic circuit such as a programmable logic circuit, an FPGA or a Programmable Logic Array (PLA) may be customized by use of state information of a computer-readable program instruction, and the electronic circuit may execute the computer-readable program instruction, thereby implementing each aspect of the disclosure.

Herein, each aspect of the disclosure is described with reference to flowcharts and/or block diagrams of the method, device (system) and computer program product according to the embodiments of the disclosure. It is to be understood that each block in the flowcharts and/or the block diagrams and a combination of each block in the flowcharts and/or the block diagrams may be implemented by computer-readable program instructions.

These computer-readable program instructions may be provided for a universal computer, a dedicated computer or a processor of another programmable data processing device, thereby generating a machine to further generate a device that realizes a function/action specified in one or more blocks in the flowcharts and/or the block diagrams when the instructions are executed through the computer or the processor of the other programmable data processing device. These computer-readable program instructions may also be stored in a computer-readable storage medium, and through these instructions, the computer, the programmable data processing device and/or another device may work in a specific manner, so that the computer-readable medium including the instructions includes a product including instructions for implementing each aspect of the function/action specified in one or more blocks in the flowcharts and/or the block diagrams.

These computer-readable program instructions may further be loaded to the computer, the other programmable data processing device or the other device, so that a series of operating steps are executed in the computer, the other programmable data processing device or the other device to generate a process implemented by the computer to further realize the function/action specified in one or more blocks in the flowcharts and/or the block diagrams by the instructions executed in the computer, the other programmable data processing device or the other device.

The flowcharts and block diagrams in the drawings illustrate probably implemented system architectures, functions and operations of the system, method and computer program product according to multiple embodiments of the disclosure. On this aspect, each block in the flowcharts or the block diagrams may represent part of a module, a program segment or an instruction, and part of the module, the program segment or the instruction includes one or more executable instructions configured to realize a specified logical function. In some alternative implementations, the functions marked in the blocks may also be realized in a sequence different from those marked in the drawings. For example, two continuous blocks may actually be executed substantially concurrently and may also be executed in a reverse sequence sometimes, which is determined by the involved functions. It is further to be noted that each block in the block diagrams and/or the flowcharts and a combination of the blocks in the block diagrams and/or the flowcharts may be implemented by a dedicated hardware-based system configured to execute a specified function or operation or may be implemented by a combination of a special hardware and a computer instruction.

Each embodiment of the disclosure has been described above. The above descriptions are exemplary, non-exhaustive and also not limited to each disclosed embodiment. Many modifications and variations are apparent to those of ordinary skill in the art without departing from the scope and spirit of each described embodiment of the disclosure. The terms used herein are selected to explain the principle and practical application of each embodiment or technical improvements in the technologies in the market best or enable others of ordinary skill in the art to understand each embodiment disclosed herein.

1. An access control method, comprising:
recognizing a collected image to be recognized to obtain a recognition result, wherein the image to be recognized comprises a present graphic code;
in condition that the recognition result indicates that the present graphic code is a target graphic code, obtaining user information and generation time contained in the present graphic code by parsing the present graphic code; and
controlling an access control device to be opened according to the user information and generation time in the present graphic code.

2. The method of claim 1, wherein recognizing the collected image to be recognized to obtain the recognition result comprises:
acquiring the present graphic code;
parsing the present graphic code to obtain character information; and
decrypting the character information in a preset decryption manner to obtain the recognition result of the present graphic code.

3. The method of claim 1, further comprising:
in condition that the recognition result indicates that the present graphic code is a non-target graphic code, uploading the present graphic code to a server, wherein the server is configured to perform access authority verification on the present graphic code;
receiving a verification result returned by the server;
in condition that the verification result indicates that verification succeeds, controlling the access control device to be opened; and
in condition that the verification result indicates that the verification fails, outputting prompt information indicating that the verification fails.

4. The method of claim 1, wherein controlling the access control device to be opened according to the user information and generation time contained in the present graphic code comprises:
determining whether a present user and a previous user are a same user according to the user information in the present graphic code;
in response to determining that the present user and the previous user are the same user, acquiring a first time interval between collection time of the present graphic code and collection time of a previous graphic code; and
controlling the access control device to be opened according to the first time interval and the generation time of the present graphic code.

5. The method of claim 4, wherein determining whether the present user and the previous user are the same user according to the user information in the present graphic code comprises:
determining whether the user information in the present graphic code is the same as user information in the previous graphic code; and
in response to determining that the user information in the present graphic code is the same as the user information in the previous graphic code, determining that the present user and the previous user are the same user, or in response to determining that the user information in the present graphic code is different from the user information in the previous graphic code, determining that the present user and the previous user are different users.

6. The method of claim 4, wherein controlling the access control device to be opened according to the first time interval and the generation time of the present graphic code comprises:
in condition that the first time interval is greater than or equal to a first threshold, acquiring a second time interval between the generation time of the present graphic code and the collection time of the present graphic code, and acquiring generation time of the previous graphic code;
in condition that the second time interval is less than a second threshold and the generation time of the present graphic code is different from the generation time of the previous graphic code, acquiring permitted access time of the present user; and
in condition that the collection time of the present graphic code is within the permitted access time, controlling the access control device to be opened.

7. The method of claim 6, further comprising: in condition that the collection time of the present graphic code is not within the permitted access time, outputting prompt information indicating that the collection time is not within the permitted access time.

8. The method of claim 6, further comprising: in condition that the second time interval is greater than or equal to the second threshold or the generation time of the present graphic code is the same as the generation time of the previous graphic code, outputting prompt information.

9. The method of claim 4, further comprising:
in condition that the present user and the previous user are different users, updating stored user information and generation information in the previous graphic code by using the user information and generation time in the present graphic code, and updating stored collection time of the previous graphic code by using the collection time of the present graphic code;
acquiring a second time interval between the generation time of the present graphic code and the collection time of the present graphic code;
in condition that the second time interval is less than a third threshold, acquiring a permitted access time corresponding to the present user; and
in condition that the collection time of the present graphic code is within the permitted access time, controlling the access control device to be opened.

10. The method of claim 9, further comprising: in condition that the collection time of the present graphic code is not within the permitted access time, outputting prompt information indicating that the collection time is not within the permitted access time.

11. The method of claim 9, further comprising: in condition that the second time interval is greater than or equal to the third threshold, recollecting a graphic code.

12. The method of claim 1, wherein after controlling the access control device to be opened, the method further comprises: updating collection time of a previous graphic code by using collection time of the present graphic code.

13. The method of claim 1, wherein the image to be recognized comprises a face image; and
the method further comprises: comparing the face image and a pre-stored face image to obtain a comparison result, and controlling access control device to be opened according to the comparison result.

14. An access control device, comprising:
a processor; and
a memory, configured to store instructions executable by the processor,
wherein the processor is configured to:
recognize a collected image to be recognized to obtain a recognition result, wherein the image to be recognized comprises a present graphic code;
obtain user information and generation time contained in the present graphic code by parsing the present graphic code in condition that the recognition result indicates that the present graphic code is a target graphic code; and
control an access control device to be opened according to the user information and generation time in the present graphic code.

15. The device of claim 14, wherein the processor is specifically configured to acquire the present graphic code, parse the present graphic code to obtain character information, and decrypt the character information in a preset decryption manner to obtain the recognition result of the present graphic code.

16. The device of claim 14, wherein the processor is further configured to:
upload the present graphic code to a server in condition that the recognition result indicates that the present graphic code is a non-target graphic code, wherein the server is configured to perform access authority verification on the present graphic code; and
receive a verification result returned by the server;
control the access control device to be opened in condition that the verification result indicates that verification succeeds; and
output prompt information indicating that the verification fails in condition that the verification result indicates that the verification fails.

17. The device of claim 14, wherein the processor is specifically configured to:
determine whether a present user and a previous user are a same user according to the user information in the present graphic code;
in response to determining that the present user and the previous user are the same user, acquire a first time interval between collection time of the present graphic code and collection time of a previous graphic code; and
control an access control device to be opened according to the first time interval and the generation time of the present graphic code.

18. The device of claim 17, wherein the processor is specifically configured to:
determine whether the user information in the present graphic code is the same as user information in the previous graphic code; and
in response to determining that the user information in the present graphic code is the same as the user information in the previous graphic code, determine that the present user and the previous user are the same user, or in response to determining that the user information in the present graphic code is different from the user information in the previous graphic code, determine that the present user and the previous user are different users.

19. The device of claim 17, wherein the processor is specifically configured to:
in condition that the first time interval is greater than or equal to a first threshold, acquire a second time interval between the generation time of the present graphic code and the collection time of the present graphic code, and acquire generation time of the previous graphic code;
in condition that the second time interval is less than a second threshold and the generation time of the present graphic code is different from the generation time of the previous graphic code, acquire permitted access time of the present user; and
in condition that the collection time of the present graphic code is within the permitted access time, control the access control device to be opened.

20. A non-transitory computer-readable storage medium, having stored therein computer program instructions, wherein the computer program instructions, when being executed by a processor, cause the processor to implement the following operations:
recognizing a collected image to be recognized to obtain a recognition result, wherein the image to be recognized comprises a present graphic code;
in condition that the recognition result indicates that the present graphic code is a target graphic code, obtaining user information and generation time contained in the present graphic code by parsing the present graphic code; and
controlling an access control device to be opened according to the user information and generation time in the present graphic code.
